(19) United States
(12) Patent Application Publication
(10) Pub. No.: US 2025/0254142 A1
(43) Pub. Date: Aug. 7, 2025

(54) INTERWORKING OF STUN AND ALG

(71) Applicant: Palo Alto Networks, Inc., Santa Clara, CA (US)

(72) Inventor: Ali Awais, Santa Clara, CA (US)

(21) Appl. No.: 18/432,878

(22) Filed: Feb. 5, 2024

(51) Int. Cl. H04L 61/2575; H04L 9/40; H04L 61/255

(52) U.S. Cl. CPC H04L 61/2585; H04L 61/255; H04L 61/2575; H04L 63/0236; H04L 63/029

(57) ABSTRACT

Techniques for interworking of STUN and application-layer gateway (ALG) technologies are disclosed. In some embodiments, a system, a process, and/or a computer program product for interworking of STUN and ALG technologies includes monitoring network traffic at an application-layer gateway (ALG) entity (e.g., a firewall, such as a next generation firewall (NGFW)); processing a Layer 7 payload at the ALG entity to extract an IP address to be translated using network address translation (NAT); performing a lookup in a NAT table to determine if the IP address has been previously translated through a Session Traversal Utilities for NAT (STUN); and automatically generating a pinhole based on the original non-NATed address and the NATed address if the IP address was previously translated through STUN.

### BACKGROUND OF THE INVENTION

A firewall generally protects networks from unauthorized access while permitting authorized communications to pass through the firewall. A firewall is typically a device or a set of devices, or software executed on a device, such as a computer, which provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRA WINGS

Various embodiments of the invention are disclosed in the following detailed description and the accompanying drawings.

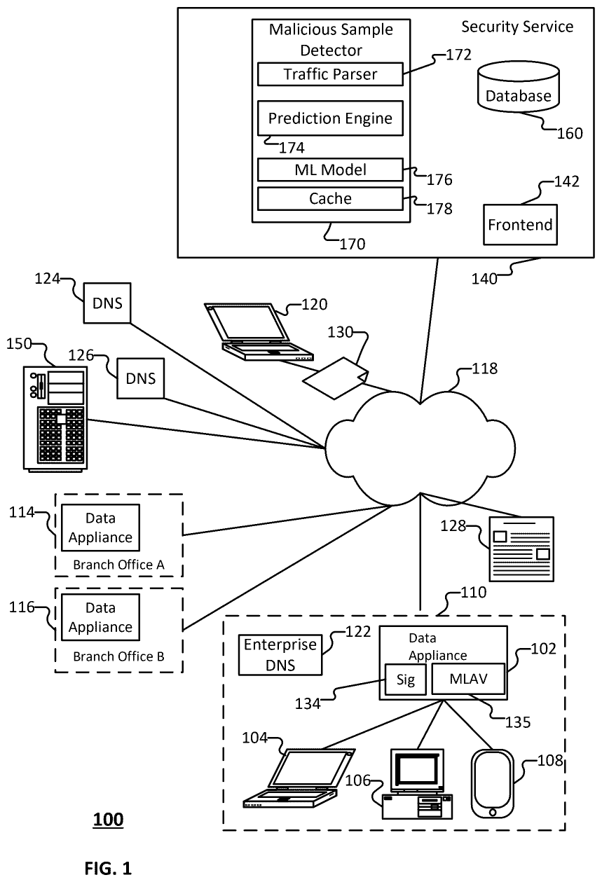

FIG. 1 is a block diagram of an environment in which malicious traffic is detected or suspected in accordance with some embodiments.

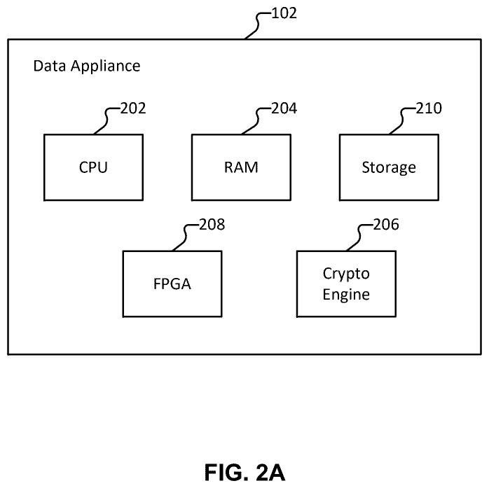

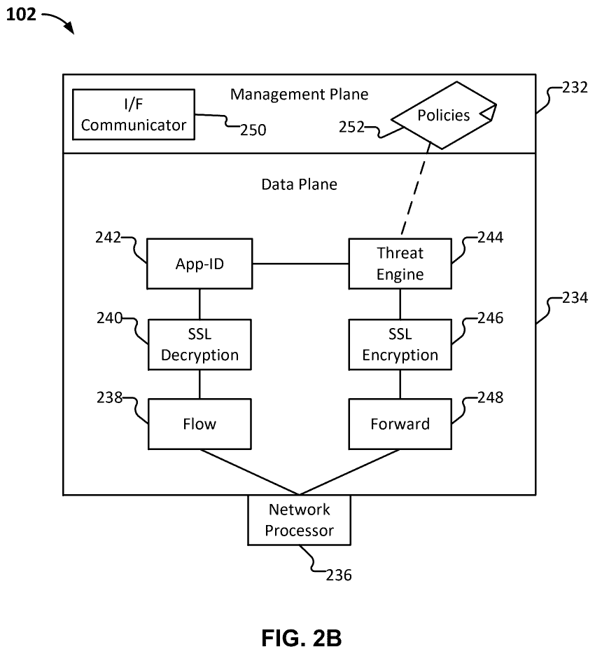

FIG. 2A illustrates an embodiment of a data appliance.

FIG. 2B is a functional diagram of logical components of an embodiment of a data appliance.

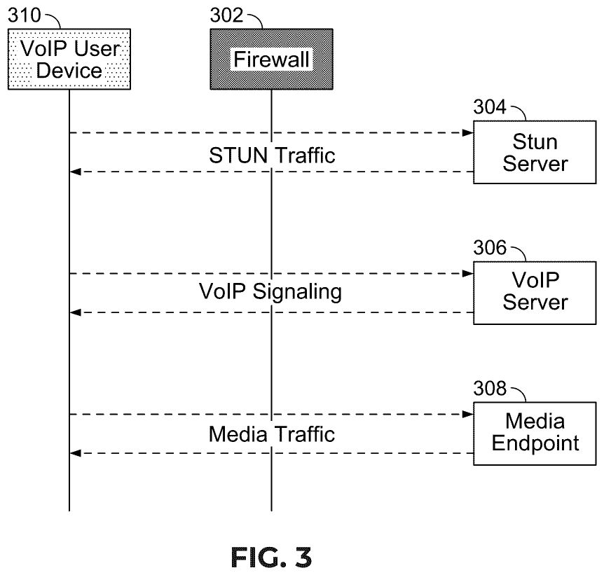

FIG. 3 illustrates a VoIP networking environment for which the disclosed techniques for interworking of STUN and ALG technologies can be effectively and efficiently applied in accordance with some embodiments.

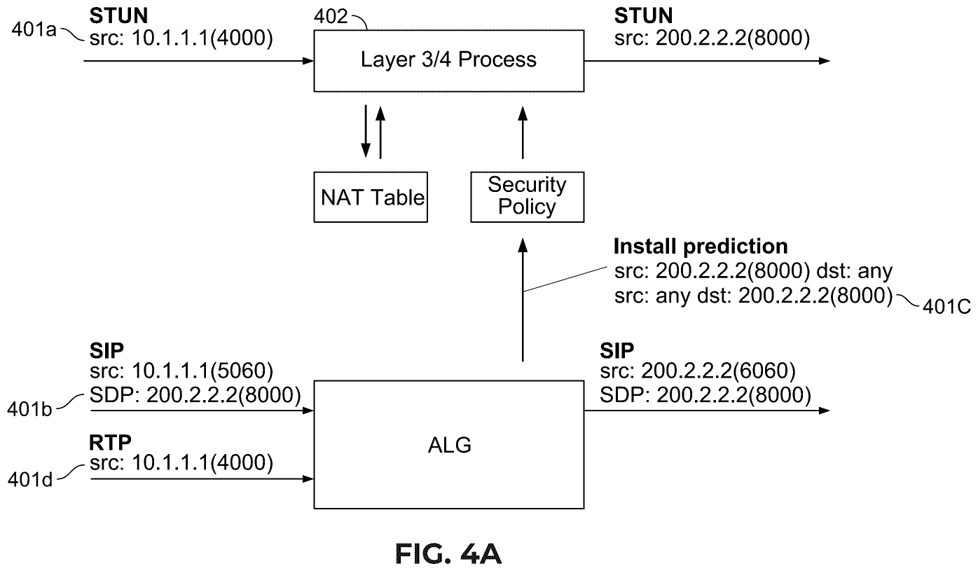

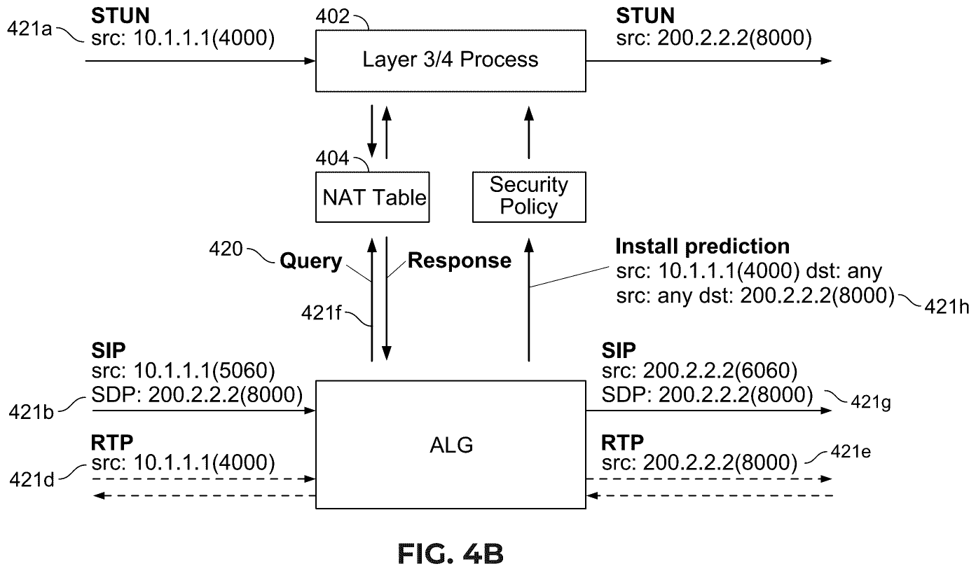

FIG. 4A illustrates an overview of the lack of interworking of existing STUN and application-layer gateway (ALG) technologies.

FIG. 4B illustrates an overview of an architecture for interworking of STUN and application-layer gateway (ALG) technologies in accordance with some embodiments.

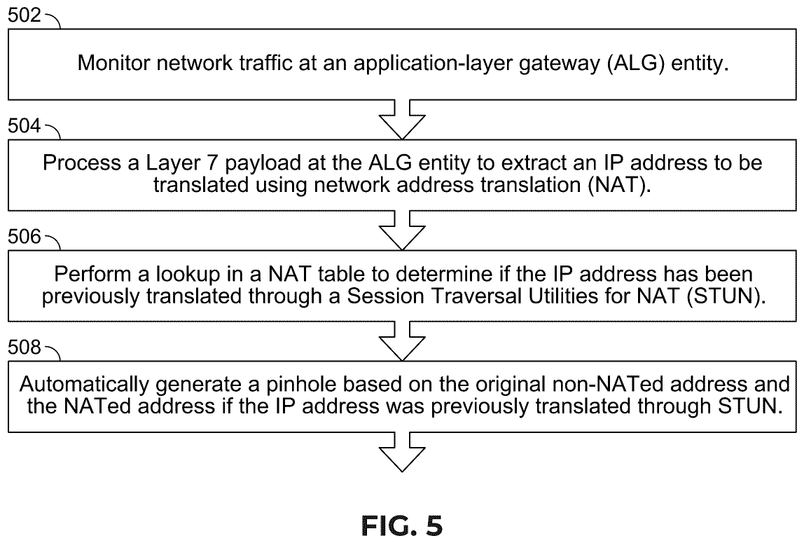

FIG. 5 is a flow diagram for interworking of STUN and ALG technologies in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all these specific details. For the purpose of clarity, technical material that is known in the technical fields related to the invention has not been described in detail so that the invention is not unnecessarily obscured.

### Advanced or Next Generation Firewalls

Malware is a general term commonly used to refer to malicious software (e.g., including a variety of hostile, intrusive, and/or otherwise unwanted software). Malware can be in the form of code, scripts, active content, and/or other software. Example uses of malware include disrupting computer and/or network operations, stealing proprietary information (e.g., confidential information, such as identity, financial, and/or intellectual property related information), and/or gaining access to private/proprietary computer systems and/or computer networks. Unfortunately, as techniques are developed to help detect and mitigate malware, nefarious authors find ways to circumvent such efforts. Accordingly, there is an ongoing need for improvements to techniques for identifying and mitigating malware.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices, and in some implementations, certain operations can be implemented in special purpose hardware, such as an ASIC or FPGA).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as described herein). A firewall can also filter local network (e.g., intranet) traffic by similarly applying a set of rules or policies.

Security devices (e.g., security appliances, security gateways, security services, and/or other security devices) can perform various security operations (e.g., firewall, anti-malware, intrusion prevention/detection, proxy, and/or other security functions), networking functions (e.g., routing, Quality of Service (QOS), workload balancing of network related resources, and/or other networking functions), and/or other security and/or networking related operations. For example, routing can be performed based on source information (e.g., IP address and port), destination information (e.g., IP address and port), and protocol information (e.g., layer-3 IP-based routing).

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques.

For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls).

For example, Palo Alto Networks' next generation firewalls enable enterprises to identify and control applications, users, and content—not just ports, IP addresses, and packets—using various identification technologies, such as the following: App-ID for accurate application identification, User-ID for user identification (e.g., by user or user group), and Content-ID for real-time content scanning (e.g., controls web surfing and limits data and file transfers). These identification technologies allow enterprises to securely enable application usage using business-relevant concepts, instead of following the traditional approach offered by traditional port-blocking firewalls.

Also, special purpose hardware for next generation firewalls implemented, for example, as dedicated appliances generally provide higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' firewalls, which support various commercial virtualized environments, including, for example, VMware® ESXi™ and NSX™, Citrix® Netscaler SDX™ KVM/OpenStack (Centos/RHEL, Ubuntu®), and Amazon Web Services (AWS)).

For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

### Technical Challenges for Interworking for Cloud Security Services

Generally, Session Traversal Utilities for NAT (STUN) provides an existing technology that facilitates communicating with users (e.g., user devices, such as a phone, laptop computer, Internet of Things (IoT) devices, etc.) behind a network address translation (NAT) entity/platform. Examples of such NAT devices include a router or firewall, such as a next generation firewall (NGFW), etc. The initiating party sends probes to an external STUN server on the Internet, to learn about its public IP address and the type of NAT it is behind. It is then up to the initiating device/process to use the information obtained through STUN, to decide the best policy for NAT traversal.

Application Layer Gateway or ALG is another existing technology for NAT traversal. ALG does not require any external entities or NAT traversal intelligence in the communicating devices. It is embedded in the NAT device itself such as NGFW and transparently modifies the Network Layer 7 traffic to enable seamless operation across the NAT device.

Specifically, STUN and ALG are two different existing technologies designed to help protocols that send out of band data and work across NAT entities/platforms. However, these two technologies were not engineered to be used together (e.g., STUN has a built-in mechanism to foil any ALGs on the network path). For example, clients can use STUN if the NAT device on the edge of the network does not have an ALG. Conversely, if the NAT device is also an ALG, then the clients generally should not use STUN.

Customers could attempt to address the incompatibility of STUN with their ALG/firewall devices (e.g., NGFW) through manual configuration at their ALG/firewall devices. Such manual configuration is burdensome, error prone, and can create security holes/risks to the enterprise's security policy(ies). Also, customers may not have the ability or resources to reconfigure every device on the network to use either STUN or ALG.

However, there exists use cases in which it is desirable to use STUN together with ALG. For example, it may not be possible to turn off STUN on user devices and a strict firewall would not allow sessions from outside even though they are being sent to translated IP addresses learned through STUN.

Thus, new and improved techniques are needed for interworking of STUN and application-layer gateway (ALG) technologies.

### Overview of Techniques for Interworking of Stun and ALG

Accordingly, new and improved techniques for interworking of Session Traversal Utilities for NAT (STUN) and application-layer gateway (ALG) technologies are disclosed.

In some embodiments, a system, a process, and/or a computer program product for interworking of STUN and application-layer gateway (ALG) technologies includes monitoring network traffic at an application-layer gateway (ALG) entity (e.g., a firewall, such as a next generation firewall (NGFW)); processing a Layer 7 payload at the ALG entity to extract an IP address to be translated using network address translation (NAT); performing a lookup in a shared NAT table to determine if the IP address has been previously translated through a Session Traversal Utilities for NAT (STUN); and automatically generating a temporary pinhole in the security policy based on the original IP address and its NAT translation learned through the STUN protocol.

For example, the ALG entity can be configured to automatically adapt to a new STUN session to generate a pinhole for the STUN session based on an original client address.

As such, using the disclosed techniques, one or more VOIP devices that use STUN for NAT traversal or use the ALG entity for NAT traversal can be effectively and efficiently deployed together behind the ALG entity, and moreover, a special configuration for each device is not required to provide seamless support for interworking of STUN and the ALG entity.

In some embodiments, a system, a process, and/or a computer program product for interworking of STUN and application-layer gateway (ALG) technologies includes performing an interface call to install a predict that is added to a session table associated with the ALG entity.

In an example implementation, the application-layer gateway (ALG) can be made aware of STUN traffic and be configured to automatically adapt itself to open policy pinholes for data traffic based on the original client address. Specifically, the ALG parses the Layer 7 payload of the application traffic and extracts the addresses that need to be translated using network address translation (i.e., NATed). The ALG can then perform a lookup in an address translation table to determine if the address has been previously translated through STUN. If an entry is found in the address translation table, then the ALG will then proceed to create a pinhole based on the original non-NATed address and the NATed address, without creating a new NAT translation that would conflict with the one previously created from a STUN exchange.

For example, the disclosed techniques for providing interworking of STUN and ALG technologies can be applied to allow for VoIP devices that use STUN for NAT traversal and those that use ALG for NAT traversal to be deployed together behind the same security platform (e.g., an Application firewall, such as NGFW and/or another security gateway), and they will both work without NAT related conflicts/issues.

In addition, the disclosed techniques for providing interworking of STUN and ALG technologies can be applied to allow for VOIP devices that use STUN for NAT traversal and those that use ALG for NAT traversal to be deployed together behind the same security platform (e.g., an ALG firewall, such as NGFW and/or another ALG security gateway), and there is no need to create special configuration rules for each individual device, which is burdensome and error prone for information technology (IT)/network/security administrators.

These and other aspects and embodiments for interworking of STUN and ALG technologies will now be further described below.

### System Embodiments for Interworking of Stun and ALG

FIG. 1 is a block diagram of an environment in which malicious traffic is detected or suspected in accordance with some embodiments. In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy) regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. In some embodiments, data appliance 102 is also configured to enforce policies with respect to traffic that stays within (or from coming into) enterprise network 110.

In the example shown, data appliance 102 is a security platform, also referred to herein as an inline security entity. Data appliance 102 performs low-latency processing/analysis of incoming data (e.g., traffic data) and determines whether to offload any processing of the incoming data to a cloud system, such as security service 140 (e.g., which includes a frontend 142, such as for communications with security platforms, such as data appliance 102, etc.).

Techniques described herein can be used in conjunction with a variety of platforms (e.g., desktops, mobile devices, gaming platforms, embedded systems, etc.) and/or a variety of types of applications (e.g., Android.apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with a remote security service 140 (e.g., a cloud-based security service, also referred to as a cloud service or a cloud security service). Security service 140 may be a cloud system such as a cloud service security entity. Security service 140 can provide a variety of services, including performing static and dynamic analysis on malware samples, providing a list of signatures of known exploits (e.g., malicious input strings, malicious files, etc.) to data appliances, such as data appliance 102 as part of a subscription, detecting exploits such as malicious input strings or malicious files (e.g., an on-demand detection, or periodical-based updates to a mapping of input strings or files to indications of whether the input strings or files are malicious or benign), providing a likelihood that an input string or file is malicious or benign, providing/updating a whitelist of input strings or files deemed to be benign, providing/updating input strings or files deemed to be malicious, identifying malicious input strings, detecting malicious input strings, detecting malicious files, predicting whether an input string or file is malicious, and providing an indication that an input string or file is malicious (or benign). In various embodiments, results of analysis (and additional information pertaining to applications, domains, etc.) are stored in database 160. In various embodiments, security service 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security service 140 can be implemented across a scalable infrastructure comprising multiple such servers, solid state drives, and/or other applicable high-performance hardware. Security service 140 can comprise several distributed components, including components provided by one or more third parties. For example, portions or all of security service 140 can be implemented using the Amazon Elastic Compute Cloud (EC2) and/or Amazon Simple Storage Service (S3). Further, as with data appliance 102, whenever security service 140 is referred to as performing a task, such as storing data or processing data, it is to be understood that a sub-component or multiple sub-components of security service 140 (whether individually or in cooperation with third party components) may cooperate to perform that task. As one example, security service 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security service 140 but may also be provided by a third party. As one example, the virtual machine server can rely on EC2, with the remainder portions of security service 140 provided by dedicated hardware owned by and under the control of the operator of security service 140.

In some embodiments, system 100 (e.g., malicious sample detector 170, security service 140, etc.) trains a detection model to detect exploits (e.g., malicious samples), malicious traffic, and/or other malicious/nefarious/undesirable activity/behavior, etc. Security service 140 may store block lists, allowed lists, etc. with respect to data (e.g., mappings of signatures to malicious files, etc.). In response to processing traffic data, security service 140 may send an update to inline security entities, such as data appliance 102. For example, security service 140 provides an update to a mapping of signatures to malicious files, an update to a mapping of signatures to benign files, etc.

According to various embodiments, the model(s) trained by system 100 (e.g., security service 140) are obtained using a machine learning process (e.g., implementing various machine learning techniques (MLT)). Examples of machine learning processes that can be implemented in connection with training the model(s) include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc. In some embodiments, the system trains an XGBoost machine learning classifier model. As an example, inputs to the classifier (e.g., the XGBoost machine learning classifier model) are a combined feature vector or set of feature vectors and based on the combined feature vector or set of feature vectors the classifier model determines whether the corresponding traffic (e.g., input string) is malicious, or a likelihood that the traffic is malicious (e.g., whether the traffic is exploit traffic).

According to various embodiments, security service 140 includes a malicious sample detector 170. Malicious sample detector 170 is used in connection with determining whether a sample (e.g., traffic data) is malicious. In response to receiving a sample (e.g., an input string such as an input string input in connection with a log-in attempt), malicious sample detector 170 analyzes the sample (e.g., the input string), and determines whether the sample is malicious. For example, malicious sample detector 170 determines one or more feature vectors for the sample (e.g., a combined feature vector), and uses a model to determine (e.g., predict) whether the sample is malicious. Malicious sample detector 170 determines whether the sample is malicious based at least in part on one or more attributes of the sample. In some embodiments, malicious sample detector 170 receives a sample, performs a feature extraction (e.g., a feature extraction with respect to one or more attributes of the input string), and determines (e.g., predicts) whether the sample (e.g., an SQL or command injection string) is malicious based at least in part on the feature extraction results. For example, malicious sample detector 170 uses a classifier (e.g., a detection model) to determine (e.g., predict) whether the sample is malicious based at least in part on the feature extraction results. In some embodiments, the classifier corresponds to a model (e.g., the detection model) to determine whether a sample is malicious, and the model is trained using a machine learning process.

In some embodiments, malicious sample detector 170 comprises one or more of traffic parser 172, prediction engine 174, ML model 176, and/or cache 178.

Traffic parser 172 is used in connection with determining (e.g., isolating) one or more attributes associated with a sample being analyzed. As an example, in the case of a file, traffic parser 172 can parse/extract information from the file, such as from a header of the file. The information obtained from the file may include libraries, functions, or files invoked/called by the file being analyzed, an order of calls, etc. As another example, in the case of an input string, traffic parser 172 determines sets of alphanumeric characters or values associated with the input string. In some embodiments, traffic parser 172 obtains one or more attributes associated with (e.g., from) the input string. For example, traffic parser 172 obtains from the input string one or more patterns (e.g., a pattern of alphanumeric characters), one or more sets of alphanumeric characters, one or more commands, one or more pointers or links, one or more IP addresses, etc.

In some embodiments, one or more feature vectors corresponding to the input string are determined by malicious sample detector 170 (e.g., traffic parser 172 or prediction engine 174). For example, the one or more feature vectors are determined (e.g., populated) based at least in part on the one or more characteristics or attributes associated with the sample (e.g., the one or more attributes or set of alphanumeric characters or values associated with the input string in the case that the sample is an input string). As an example, traffic parser 172 uses the one or more attributes associated with the sample in connection with determining the one or more feature vectors. In some implementations, traffic parser 172 determines a combined feature vector based at least in part on the one or more feature vectors corresponding to the sample. As an example, a set of one or more feature vectors is determined (e.g., set or defined) based at least in part on the model used to detect exploits. Malicious sample detector 170 can use the set of one or more feature vectors to determine the one or more attributes of patterns that are to be used in connection with training or implementing the model (e.g., attributes for which fields are to be populated in the feature vector, etc.). The model may be trained using a set of features that are obtained based at least in part on sample malicious traffic, such as a set of features corresponding to predefined regex statements and/or a set of feature vectors determined based on an algorithmic-based feature extraction. For example, the model is determined based at least in part on performing a malicious feature extraction in connection with generating (e.g., training) a model to detect exploits. The malicious feature extraction can include one or more of (i) using predefined regex statements to obtain specific features from files, or SQL and command injection strings, and (ii) using an algorithmic-based feature extraction to filter out described features from a set of raw input data.

In response to receiving a sample for which malicious sample detector 170 is to determine whether the sample is malicious (or a likelihood that the sample is malicious), malicious sample detector 170 determines the one or more feature vectors (e.g., individual feature vectors corresponding to a set of predefined regex statements, individual feature vectors corresponding to attributes or patterns obtained using an algorithmic-based analysis of exploits, and/or a combined feature vector of both, etc.). As an example, in response to determining (e.g., obtaining) the one or more feature vectors, malicious sample detector 170 (e.g., traffic parser 172) provides (or makes accessible) the one or more feature vectors to prediction engine 174 (e.g., in connection with obtaining a prediction of whether the sample is malicious). As another example, malicious sample detector 170 (e.g., traffic parser 172) stores the one or more feature vectors such as in cache 178 or database 160.

In some embodiments, prediction engine 174 determines whether the sample is malicious based at least in part on one or more of (i) a mapping of samples to indications of whether the corresponding samples are malicious, (ii) a mapping of an identifier for a sample (e.g., a hash or other signature associated with the sample) to indications of whether the corresponding sample is malicious, and/or (iii) a classifier (e.g., a model trained using a machine learning process). In some embodiments, determining whether the sample based on identifiers to indications that the sample is malicious may be performed at data appliance 102, and for a sample for which an associated identifier is not stored in the mapping(s), data appliance 102 offloads processing of the sample to security service 140.

Prediction engine 174 is used to predict whether a sample is malicious. In some embodiments, prediction engine 174 determines (e.g., predicts) whether a received sample is malicious. According to various embodiments, prediction engine 174 determines whether a newly received sample is malicious based at least in part on characteristics/attributes pertaining to the sample (e.g., regex statements, information obtained from a file header, calls to libraries, APIs, etc.). For example, prediction engine 174 applies a machine learning model to determine whether the newly received sample is malicious. Applying the machine learning model to determine whether the sample is malicious may include prediction engine 174 querying machine learning model 176 (e.g., with information pertaining to the sample, one or more feature vectors, etc.). In some implementations, machine learning model 176 is pre-trained and prediction engine 174 does not need to provide a set of training data (e.g., sample malicious traffic and/or sample benign traffic) to machine learning model 176 contemporaneous with a query for an indication/determination of whether a particular sample is malicious. In some embodiments, prediction engine 174 receives information associated with whether the sample is malicious (e.g., an indication that the sample is malicious). For example, prediction engine 174 receives a result of a determination or analysis by machine learning model 176. In some embodiments, prediction engine 174 receives from machine learning model 176 an indication of a likelihood that the sample is malicious. In response to receiving the indication of the likelihood that the sample is malicious, prediction engine 174 determines (e.g., predicts) whether the sample is malicious based at least in part on the likelihood that the sample is malicious. For example, prediction engine 174 compares the likelihood that the sample is malicious to a likelihood threshold value. In response to a determination that the likelihood that the sample is malicious is greater than a likelihood threshold value, prediction engine 174 may deem (e.g., determine that) the sample to be malicious.

According to various embodiments, in response to prediction engine 174 determining that the received sample is malicious, security service 140 sends to a security entity (e.g., data appliance 102) an indication that the sample is malicious. For example, malicious sample detector 170 may send to an inline security entity (e.g., a firewall) or network node (e.g., a client) an indication that the sample is malicious. The indication that the sample is malicious may correspond to an update to a block list of samples (e.g., corresponding to malicious samples) such as in the case that the received sample is deemed to be malicious, or an update to an allowed list of samples (e.g., corresponding to non-malicious samples) such as in the case that the received sample is deemed to be benign. In some embodiments, malicious sample detector 170 sends a hash or signature corresponding to the sample in connection with the indication that the sample is malicious or benign. The security entity or endpoint may compute a hash or signature for a sample and perform a look up against a mapping of hashes/signatures to indications of whether samples are malicious/benign (e.g., query an allow list and/or a block list). In some embodiments, the hash or signature uniquely identifies the sample.

Prediction engine 174 is used in connection with determining whether the sample (e.g., an input string) is malicious (e.g., determining a likelihood or prediction of whether the sample is malicious). Prediction engine 174 uses information pertaining to the sample (e.g., one or more attributes, patterns, etc.) in connection with determining whether the corresponding sample is malicious.

In response to receiving a sample to be analyzed, malicious sample detector 170 can determine whether the sample corresponds to a previously analyzed sample (e.g., whether the sample matches a sample associated with historical information for which a maliciousness determination has been previously computed). As an example, malicious sample detector 170 determines whether an identifier or representative information corresponding to the sample is comprised in the historical information (e.g., a block list, an allow list, etc.). In some embodiments, representative information corresponding to the sample is a hash or signature of the sample. In some embodiments, malicious sample detector 170 (e.g., prediction engine 174) determines whether information pertaining to a particular sample is comprised in a dataset of historical input strings and historical information associated with the historical dataset indicating whether a particular sample is malicious (e.g., a third-party service such as VirusTotal™). In response to determining that information pertaining to a particular sample is not comprised in, or available in, the dataset of historical input strings and historical information, malicious sample detector 170 may deem the sample has not yet been analyzed and malicious sample detector 170 can invoke an analysis (e.g., a dynamic analysis) of the sample in connection with determining (e.g., predicting) whether the sample is malicious (e.g., malicious sample detector 170 can query a classifier based on the sample in connection with determining whether the sample is malicious). An example of the historical information associated with the historical samples indicating whether a particular sample is malicious corresponds to a VirusTotal® (VT) score. In the case of a VT score greater than 0 for a particular sample, the particular sample is deemed malicious by the third-party service. In some embodiments, the historical information associated with the historical samples indicating whether a particular sample is malicious corresponds to a social score such as a community-based score or rating (e.g., a reputation score) indicating that a sample is malicious or likely to be malicious. The historical information (e.g., from a third-party service, a community-based score, etc.) indicates whether other vendors or cyber security organizations deem the particular sample to be malicious.

In some embodiments, malicious sample detector 170 (e.g., prediction engine 174) determines that a received sample is newly analyzed (e.g., that the sample is not within the historical information/dataset, is not on an allow list or block list, etc.). Malicious sample detector 170 (e.g., traffic parser 172) may detect that a sample is newly analyzed in response to security service 140 receiving the sample from a security entity (e.g., a firewall) or endpoint within a network. For example, malicious sample detector 170 determines that a sample is newly analyzed contemporaneous with receipt of the sample by security service 140 or malicious sample detector 170. As another example, malicious sample detector 170 (e.g., prediction engine 174) determines that a sample is newly analyzed according to a predefined schedule (e.g., daily, weekly, monthly, etc.), such as in connection with a batch process. In response to determining that a sample is received that has not yet been analyzed with respect to whether such sample is malicious (e.g., the system does not comprise historical information with respect to such input string), malicious sample detector 170 determines whether to use an analysis (e.g., dynamic analysis) of the sample (e.g., to query a classifier to analyze the sample or one or more feature vectors associated with the sample, etc.) in connection with determining whether the sample is malicious, and malicious sample detector 170 uses a classifier with respect to a set of feature vectors or a combined feature vector associated with characteristics or relationships of attributes or characteristics in the sample.

Machine learning model 176 predicts whether a sample (e.g., a newly received sample) is malicious based at least in part on a model. As an example, the model is pre-stored and/or pre-trained. The model can be trained using various machine learning processes. According to various embodiments, machine learning model 176 uses a relationship and/or pattern of attributes and/or characteristics, relationships among attributes or characteristics for the sample, and/or a training set to estimate whether the sample is malicious, such as to predict a likelihood that the sample is malicious. For example, machine learning model 176 uses a machine learning process to analyze a set of relationships between an indication of whether a sample is malicious (or benign), and one or more attributes pertaining to the sample and uses the set of relationships to generate a prediction model for predicting whether a particular sample is malicious. In some embodiments, in response to predicting that a particular sample is malicious, an association between the sample and the indication that the sample is malicious is stored such as at malicious sample detector 170 (e.g., cache 178). In some embodiments, in response to predicting a likelihood that a particular sample is malicious, an association between the sample and the likelihood that the sample is malicious is stored such as at malicious sample detector 170 (e.g., cache 178). Machine learning model 176 may provide the indication of whether a sample is malicious, or a likelihood that the sample is malicious, to prediction engine 174. In some implementations, machine learning model 176 provides prediction engine 174 with an indication that the analysis by machine learning model 176 is complete and that the corresponding result (e.g., the prediction result) is stored in cache 178.

Cache 178 stores information pertaining to a sample (e.g., an input string). In some embodiments, cache 178 stores mappings of indications of whether an input string is malicious (or likely malicious) to particular input strings, or mappings of indications of whether a sample is malicious (or likely malicious) to hashes or signatures corresponding to samples. Cache 178 may store additional information pertaining to a set of samples such as attributes of the samples, hashes or signatures corresponding to a sample in the set of samples, other unique identifiers corresponding to a sample in the set of samples, etc. In some embodiments, inline security entities, such as data appliance 102, store a cache that corresponds to, or is similar to, cache 178. For example, the inline security entities may use the local caches to perform inline processing of traffic data, such as low-latency processing.

Returning to FIG. 1, suppose that a malicious individual (using client device 120) has created malware or malicious input string 130. The malicious individual hopes that a client device, such as client device 104, will execute a copy of malware or other exploit (e.g., malware or malicious input string) 130, compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as command and control (C&C) server 150, as well as to receive instructions from C&C server 150, as applicable.

The environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). Enterprise DNS server 122 is configured to resolve enterprise domain names into IP addresses and is further configured to communicate with one or more external DNS servers (e.g., DNS servers 124 and 126) to resolve domain names as applicable.

In order to connect to a legitimate domain (e.g., www.example.com depicted as website 128), a client device, such as client device 104, will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C&C server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C&C server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier stored in local cache or otherwise that certain detected network traffic is to be further analyzed (e.g., using a finer detection model) such as by offloading processing to security service 140.

In various embodiments, data appliance 102 includes signatures 134 (e.g., periodically updated from security service 140) and an inline machine learning antivirus (MLAV) module 135, which is configured to facilitate ML-based malware detection (e.g., the MLAV model component can be implemented as further described in U.S. Pat. Nos. 11,374,946 and 11,636,208, which are both incorporated herein by reference in their entirety). Using processing described in more detail below, security service 140 will determine (e.g., using a malicious file detector that may be similar to malicious sample detector 170 such as by using a machine learning model to detect/predict whether the file is malicious) whether a sample (e.g., a file) is a malicious file (or likely to be a malicious file) and provide a result back to data appliance 102 (e.g., “malicious file” or “benign file”).

In some embodiments, malicious sample detector 170 provides to a security entity, such as data appliance 102, an indication whether a sample is malicious. For example, in response to determining that the sample is malicious, malicious sample detector 170 sends an indication that the sample is malicious to data appliance 102, and the data appliance may in turn enforce one or more security policies based at least in part on the indication that the sample is malicious. The one or more security policies may include isolating/quarantining the input string or file, deleting the sample, ensuring that the sample is not executed or resolved, alerting or prompting the user of the maliciousness of the sample prior to the user opening/executing the sample, etc. As another example, in response to determining that the sample is malicious, malicious sample detector 170 provides to the security entity an update of a mapping of samples (or hashes, signatures, or other unique identifiers corresponding to samples) to indications of whether a corresponding sample is malicious, or an update to a blacklist for malicious samples (e.g., identifying samples) or a whitelist for benign samples (e.g., identifying samples that are not deemed malicious).

FIG. 2A illustrates an embodiment of a data appliance. An embodiment of an inline security entity, such as data appliance 102, is shown in FIG. 2A. The example shown is a representation of physical components that are included in data appliance 102, in various embodiments. Specifically, data appliance 102 includes a high-performance multi-core Central Processing Unit (CPU) 202 and Random Access Memory (RAM) 204. Data appliance 102 also includes a storage 210 (such as one or more hard disks or solid-state storage units). In various embodiments, data appliance 102 stores (whether in RAM 204, storage 210, and/or other appropriate locations) information used in monitoring enterprise network 110 and implementing disclosed techniques. Examples of such information include application identifiers, content identifiers, user identifiers, requested URLs, IP address mappings, policy and other configuration information, signatures, hostname/URL categorization information, malware profiles, and machine learning models. Data appliance 102 can also include one or more optional hardware accelerators. For example, data appliance 102 can include a cryptographic engine 206 configured to perform encryption and decryption operations, and one or more Field Programmable Gate Arrays (FPGAs) 208 configured to perform matching, act as network processors, and/or perform other tasks.

Functionality described herein as being performed by data appliance 102 can be provided/implemented in a variety of ways. For example, data appliance 102 can be a dedicated device or set of devices. The functionality provided by data appliance 102 can also be integrated into or executed as software on a general-purpose computer, a computer server, a gateway, and/or a network/routing device. In some embodiments, at least some services described as being provided by data appliance 102 are instead (or in addition) provided to a client device (e.g., client device 104 or client device 106) by software executing on the client device.

Whenever data appliance 102 is described as performing a task, a single component, a subset of components, or all components of data appliance 102 may cooperate to perform the task. Similarly, whenever a component of data appliance 102 is described as performing a task, a subcomponent may perform the task and/or the component may perform the task in conjunction with other components. In various embodiments, portions of data appliance 102 are provided by one or more third parties. Depending on factors such as the amount of computing resources available to data appliance 102, various logical components and/or features of data appliance 102 may be omitted and the techniques described herein adapted accordingly. Similarly, additional logical components/features can be included in embodiments of data appliance 102 as applicable. One example of a component included in data appliance 102 in various embodiments is an application identification engine which is configured to identify an application (e.g., using various application signatures for identifying applications based on packet flow analysis). For example, the application identification engine can determine what type of traffic a session involves, such as Web Browsing-Social Networking; Web Browsing-News; SSH; and so on.

FIG. 2B is a functional diagram of logical components of an embodiment of a data appliance. The example shown is a representation of logical components that can be included in an inline security appliance, such as data appliance 102, in various embodiments. Unless otherwise specified, various logical components of data appliance 102 are generally implementable in a variety of ways, including as a set of one or more scripts (e.g., written in Go, Java, Python, etc., as applicable).

As shown, data appliance 102 comprises a firewall, and includes a management plane 232 and a data plane 234. The management plane is responsible for managing user interactions, such as by providing a user interface for configuring policies and viewing log data. The data plane is responsible for managing data, such as by performing packet processing and session handling. The data plane may be further responsible for offloading processing to a cloud system/service, such as by communicating a request message to the cloud system/service without mediation or forwarding the message through the management plane, such as further described herein.

Network processor 236 is configured to receive packets from client devices, such as client device 108, and provide them to data plane 234 for processing. Whenever flow module 238 identifies packets as being part of a new session, it creates a new session flow. Subsequent packets will be identified as belonging to the session based on a flow lookup. If applicable, SSL decryption is applied by SSL decryption engine 240. Otherwise, processing by SSL decryption engine 240 is omitted. Decryption engine 240 can help data appliance 102 inspect and control SSL/TLS and SSH encrypted traffic, and thus help to stop threats that might otherwise remain hidden in encrypted traffic. Decryption engine 240 can also help prevent sensitive content from leaving enterprise network 110. Decryption can be controlled (e.g., enabled or disabled) selectively based on parameters such as: URL category, traffic source, traffic destination, user, user group, and port. In addition to decryption policies (e.g., that specify which sessions to decrypt), decryption profiles can be assigned to control various options for sessions controlled by the policy. For example, the use of specific cipher suites and encryption protocol versions can be required.

Application identification (APP-ID) engine 242 is configured to determine what type of traffic a session involves. As one example, application identification engine 242 can recognize a GET request in received data and conclude that the session requires an HTTP decoder. In some cases, such as a web browsing session, the identified application can change, and such changes will be noted by data appliance 102. For example, a user may initially browse to a corporate Wiki (classified based on the URL visited as “Web Browsing-Productivity”) and then subsequently browse to a social networking site (classified based on the URL visited as “Web Browsing-Social Networking”). Different types of protocols have corresponding decoders.

Based on the determination made by application identification engine 242, the packets are sent, by threat engine 244, to an appropriate decoder configured to assemble packets (which may be received out of order) into the correct order, perform tokenization, and extract out information. Threat engine 244 also performs signature matching to determine what should happen to the packet. As needed, SSL encryption engine 246 can re-encrypt decrypted data. Packets are forwarded using a forward module 248 for transmission (e.g., to a destination).

As also shown in FIG. 2B, policies 252 are received and stored in management plane 232. Policies can include one or more rules, which can be specified using domain and/or host/server names, and rules can apply one or more signatures or other matching criteria or heuristics, such as for security policy enforcement for subscriber/IP flows based on various extracted parameters/information from monitored session traffic flows. An interface (I/F) communicator 250 is provided for management communications (e.g., via (REST) APIs, messages, or network protocol communications or other communication mechanisms).

### Interworking of Stun an ALG

Various system embodiments for seamless support of interworking of STUN and application-layer gateway (ALG) technologies are disclosed.

The below description uses SIP as the Layer 7 control protocol and RTP as the data protocol, although these procedures are applicable to any Layer 7 data transfer protocol that uses separate control and data channels.

FIG. 3 illustrates a VoIP networking environment for which the disclosed techniques for interworking of STUN and ALG technologies can be effectively and efficiently applied in accordance with some embodiments. As shown in FIG. 3, the disclosed techniques for providing interworking of STUN and ALG technologies, including an ALG/firewall entity/device/platform 302, a STUN server 304, a VOIP server 306, a media endpoint 308, and a VOIP user device (e.g., a mobile phone, laptop, and/or other network enabled/computing device) 310, can be applied to allow for VOIP devices that use STUN for NAT traversal and those that use ALG for NAT traversal to be deployed together behind the same security platform (e.g., an application firewall, such as a NGFW and/or another ALG security gateway), and such avoids opening holes in a security policy (e.g., the security policy(ies) enforced at the ALG firewall(s)/NGFW(s) for the enterprise network).

As similarly discussed above, STUN and ALG are two different existing technologies, designed to help protocols that send out of band data, to communicate across NAT devices. However, these two technologies were not designed to be used together. Enterprises can, for example, use STUN if the NAT device on the edge of the enterprise network does not have an ALG entity (e.g., an ALG/firewall device, such as an NGFW). Conversely when the NAT device is also an ALG, then the enterprises generally should not use STUN due to such lack of interworking between STUN and ALG.

FIG. 4A illustrates an overview of the lack of interworking of existing STUN and application-layer gateway (ALG) technologies. Specifically, FIG. 4A provides an approximate representation of events when clients use STUN with a session initiated protocol (SIP), and ALG is enabled on an ALG entity (e.g., a firewall/NGFW).

As shown at 401a, a client selects an IP address and port combination (e.g., 1.1.1.1 (4000)). It then sends a STUN probe to learn how the firewall will NAT this IP address.

The STUN message is processed by the Layer 3/Layer 4 process in the firewall and is NATed according to the configured NAT policy (402).

As shown at 401b, the client will then use the translated address in the SIP packet payload.

As shown at 401c, when the ALG processes this packet, it will create a temporary policy or prediction, that instructs the firewall device to allow RTP packets that are either sourced or destined to 200.2.2.2(8000).

As shown at 401d, the actual RTP traffic from the client, however, has the source (src) address 10.1.1.1(4000). There is no policy exception for this source address in place. As such, the RTP traffic will be blocked by the firewall. In other words, two-way audio communication will fail to establish due to lack of interworking of ALG and STUN, such as similarly described above.

If the ALG is disabled, then the SIP payload will not be used to create policy exceptions or pinholes. The server side will see the correct public facing address in the SIP payload, because the client already knows the public address through STUN. However, any traffic sent to this public address is dropped by the firewall as there is no pinhole or existing session to allow this traffic. As such, STUN alone is not adequate to operate VoIP protocols through the firewall. For STUN alone to operate in such a network environment, the enterprise customer would need to create a wide open security policy to allow traffic on the expected RTP ports, which is undesirable for security reasons as similarly discussed above.

Accordingly, there is a need for improved techniques to facilitate an effective and efficient interworking solution for STUN and ALG technologies.

Thus, as similarly described above, the disclosed techniques for providing interworking of STUN and ALG technologies can be applied to enable enterprise ALG/firewall customers to deploy endpoints that use STUN and those that do not together in a network and have them inter-operate seamlessly (e.g., in which public addresses in the SIP payload are not modified by the firewall but a pinhole for the RTP traffic is also created), such as will now be further described below with respect to FIG. 4B.

FIG. 4B illustrates an overview of an architecture for interworking of STUN and application-layer gateway (ALG) technologies in accordance with some embodiments. Generally, in an example implementation, the STUN handlers and ALG communicate with each other internally, to present a uniform interface. The NAT bindings generated through STUN are stored in a data store (e.g., a table, a database, and/or another form of a data store) that the ALG can query. The disclosed techniques then are configured to determine whether any embedded address needs to be NATed, pin-holed, or passed-through unchanged, such as further described below with respect to FIG. 4B illustrating the disclosed solution that can be implemented to handle STUN when ALG is present and enabled.

Specifically, as will be further described below, a preprocessing stage in L7 is performed to detect pre-NATed addresses in the payload and to then perform corrective actions. In this example implementation, the disclosed techniques perform the following processing to facilitate flawless interworking of STUN and ALG: (1) a new API 420 is used to query the L3/L4 NAT table 404 for existing mappings; and (2) ALG does not create a new NAT mapping, such as will now be further described below with respect to FIG. 4B.

Referring to FIG. 4B, an overall flow of event processing for facilitating ALG persistent NAT is provided as will now be described below.

As shown at 421a, a client selects an IP address and port combination (e.g., 1.1.1.1 (4000) to use for sending and receiving voice, and video data. STUN is used to learn how the firewall will NAT this IP address. When the Layer 3/Layer 4 process in the firewall processes the STUN message, it will create a new NAT binding and store it in a shared NAT table (404).

As shown at 421b, the client will use the translated address (200.2.2.2(8000)), learned through STUN, in the SIP message payload.

As shown at 421d, an incoming RTP packet with source address of 10.1.1.1(4000) will match the installed prediction in the security policy and will result in the establishment of a bi-directional RTP traffic as shown at 421e.

As shown at 421f, when the ALG processes the SIP packet it will query the NAT table (404) to see if the address (200.2.2.2(8000)) has been previously NATed during STUN processing.

An example implementation for API 420 is provided below.

```
  typedef struct {
    ip_addr original_addr;
    unsigned original_port
    ip_addr translated_addr;
  unsigned translated_port
  } nat_record;
  nat_record* 13_14_nat_query(ip_addr addr, unsigned port, unsigned
  &type);
  Input Parameters:
  addr IPv4 or IPv6 address
  port TCP or UDP port.
  Return Values:
  type boolean value indicating whether the original address was
  matched or the
translated.
  nat_record A pointer to the NAT record entry in the database, if the
  entry is
present otherwise a NULL value will be returned.
```

In this example use case, given that the IP address is found in the NAT table (404), the ALG will use the original address 10.1.1.1(4000) to install a prediction (421h), that instructs the firewall to allow RTP packets with source address of 10.1.1.1(4000), or a destination address of 200.2.2.2(8000).

As shown at 421g, the SDP address in SIP INVITE is left unchanged when it is transmitted out.

As shown at 421h, RTP packets match the installed prediction and a bidirectional RTP session is created.

As such, the disclosed techniques facilitate providing a secure solution for seamless support of interworking of STUN and ALG as described above with respect to FIG. 4B.

Additional example process embodiments for seamless support of interworking of STUN and ALG technologies will now be further described below.

### Process Embodiments for Interworking of Stun and ALG

FIG. 5 is a flow diagram for interworking of STUN and ALG technologies in accordance with some embodiments. In some embodiments, a process as shown in FIG. 5 is performed by an ALG entity, such as a security platform/NGFW (e.g., associated with a cloud security service), and techniques as similarly described above including the embodiments described above with respect to FIGS. 3 and 4B.

At 502, monitoring network traffic at an application-layer gateway (ALG) entity is performed. For example, the ALG entity can be implemented using a firewall (e.g., a next generation firewall (NGFW)), such as similarly described above with respect to FIG. 4B.

At 504, processing a Layer 7 payload at the ALG entity to extract an IP address to be translated using network address translation (NAT) is performed. For example, processing the Layer 7 payload at the ALG entity to extract an IP address to be translated using network address translation (NAT) can be implemented as similarly described above with respect to FIG. 4B.

At 506, performing a lookup in a NAT table to determine if the IP address has been previously translated through a Session Traversal Utilities for NAT (STUN) is performed. For example, an API call can be used to perform the lookup in the NAT table to determine if the IP address has been previously translated through STUN as similarly described above with respect to FIG. 4B.

At 508, automatically generating a pinhole based on the original non-NATed address and the NATed address if the IP address was previously translated through STUN is performed. For example, the ALG entity can be configured to automatically adapt to a new STUN session to generate a pinhole for the STUN session based on an original client address, such as similarly described above with respect to FIG. 4B.

In some embodiments, a system, a process, and/or a computer program product for interworking of STUN and application-layer gateway (ALG) technologies includes performing an interface call to install a predict that is added to a session table associated with the ALG entity, such as similarly described above with respect to FIG. 4B.

As such, using the disclosed techniques, one or more VoIP devices that use STUN for NAT traversal and use the ALG entity for NAT traversal can be effectively and efficiently deployed together behind the ALG entity, and moreover, a special configuration for each device is not required to provide seamless support for interworking of STUN and the ALG entity.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
monitor network traffic at an application-layer gateway (ALG) entity;
process a Layer 7 payload at the ALG entity to extract an IP address to be translated using network address translation (NAT);
perform a lookup in a NAT table to determine if the IP address has been previously translated through a Session Traversal Utilities for NAT (STUN); and
automatically generate a pinhole based on an original non-NATed address and a NATed address if the IP address was previously translated through the STUN; and
a memory coupled to the processor and configured to provide the processor with instructions.

2. The system of claim 1, wherein a new NAT translation that would conflict with the one created from the STUN translation is not generated if the ALG entity determines that the IP address had been previously translated through the STUN.

3. The system of claim 1, wherein the ALG entity includes a firewall.

4. The system of claim 1, wherein the ALG entity includes a Next Generation Firewall (NGFW).

5. The system of claim 1, wherein the ALG entity automatically adapts to a new STUN session to generate a pinhole for the new STUN session based on an original client address.

6. The system of claim 1, wherein a special configuration for each device is not required to provide seamless support for interworking of the STUN and the ALG entity.

7. The system of claim 1, wherein one or more VOIP devices that use the STUN for NAT traversal and use the ALG entity for NAT traversal are deployed together behind the ALG entity, and wherein a special configuration for each device is not required to provide seamless support for interworking of the STUN and the ALG entity.

8. The system of claim 1, wherein the processor is further configured to:
perform an interface call to install a predict that is added to a session table associated with the ALG entity.

9. A method, comprising:
monitoring network traffic at an application-layer gateway (ALG) entity;
processing a Layer 7 payload at the ALG entity to extract an IP address to be translated using network address translation (NAT);
performing a lookup in a NAT table to determine if the IP address has been previously translated through a Session Traversal Utilities for NAT (STUN); and
automatically generating a pinhole based on an original non-NATed address and a NATed address if the IP address was previously translated through the STUN.

10. The method of claim 9, wherein a new NAT translation that would conflict with the one created from the STUN translation is not generated if the ALG entity determines that the IP address had been previously translated through the STUN.

11. The method of claim 9, wherein the ALG entity includes a firewall.

12. The method of claim 9, wherein the ALG entity includes a Next Generation Firewall (NGFW).

13. The method of claim 9, wherein the ALG entity automatically adapts to a new STUN session to generate a pinhole for the new STUN session based on an original client address.

14. The method of claim 9, wherein a special configuration for each device is not required to provide seamless support for interworking of the STUN and the ALG entity.

15. The method of claim 9, wherein one or more VoIP devices that use the STUN for NAT traversal and use the ALG entity for NAT traversal are deployed together behind the ALG entity, and wherein a special configuration for each device is not required to provide seamless support for interworking of the STUN and the ALG entity.

16. The method of claim 9, further comprising:
performing an interface call to install a predict that is added to a session table associated with the ALG entity.

17. A computer program product embodied in a non-transitory computer readable medium and comprising computer instructions for:
monitoring network traffic at an application-layer gateway (ALG) entity;
processing a Layer 7 payload at the ALG entity to extract an IP address to be translated using network address translation (NAT);
performing a lookup in a NAT table to determine if the IP address has been previously translated through a Session Traversal Utilities for NAT (STUN); and
automatically generating a pinhole based on an original non-NATed address and a NATed address if the IP address was previously translated through the STUN.

18. The computer program product of claim 17, wherein a new NAT translation that would conflict with the one created from the STUN translation is not generated if the ALG entity determines that the IP address had been previously translated through the STUN.

19. The computer program product of claim 17, wherein the ALG entity includes a firewall.

20. The computer program product of claim 17, wherein the ALG entity automatically adapts to a new STUN session to generate a pinhole for the new STUN session based on an original client address.
